(19) United States
(12) Patent Application Publication
(10) Pub. No.: US 2024/0284231 A1
(43) Pub. Date: Aug. 22, 2024

(54) REPORTING METHOD AND APPARATUS, AND TERMINAL

(71) Applicant: VIVO MOBILE COMMUNICATION CO., LTD., Dongguan (CN)

(72) Inventors: Chenxi WANG, Dongguan (CN); Peng SUN, Dongguan (CN); Li CHEN, Dongguan (CN)

(73) Assignee: VIVO MOBILE COMMUNICATION CO., LTD., Dongguan (CN)

(21) Appl. No.: 18/650,078

(22) Filed: Apr. 30, 2024

Related U.S. Application Data
(63) Continuation of application No. PCT/CN2022/129251, filed on Nov. 2, 2022.

(30) Foreign Application Priority Data
Nov. 4, 2021 (CN) 202111302307.3

(51) Int. Cl. H04W 24/10; H04B 7/06; H04W 74/0833

(52) U.S. Cl. CPC H04W 24/10; H04B 7/06968; H04W 74/0833

(57) ABSTRACT

A reporting method, a terminal, and a non-transitory computer-readable storage medium are provided. The reporting method includes: performing, by a terminal, layer 1 measurement; and when a layer 1 measurement result meets a first condition, reporting, by the terminal, the layer 1 measurement result. The first condition corresponds to an event configured by a network-side device.

### CROSS-REFERENCE TO RELATED APPLICATIONS

This application is a continuation of International Application No. PCT/CN2022/129251, filed on Nov. 2, 2022, which claims priority to Chinese Patent Application No. 202111302307.3, filed on Nov. 4, 2021. The entire contents of each of the above-referenced applications are expressly incorporated herein by reference.

### TECHNICAL FIELD

This application pertains to the field of communications technologies, and specifically relates to a reporting method and apparatus, and a terminal.

### BACKGROUND

In a related mobility measurement technology, all measurement results of beam measurement and cell measurement of neighboring cells can be reported only at Layer 3 (L3), and are limited to a Synchronization Signal/Physical Broadcast Channel (SS/PBCH) block Measurement Timing Configuration (SMTC). Because the measurement results reported at layer 3 are obtained through temporal smoothing filtering of layer 1 measurement results, it takes a network-side device a long time to obtain the measurement results. Consequently, real-time performance of mobility management is poor.

### SUMMARY

Embodiments of this application provide a reporting method and apparatus, and a terminal.

According to a first aspect, a reporting method is provided and includes:
performing, by a terminal, layer 1 measurement; and
in a case that a layer 1 measurement result meets a first condition, reporting, by the terminal, the layer 1 measurement result, where the first condition corresponds to an event configured by a network-side device.

According to a second aspect, a reporting apparatus is provided and includes:
a measurement module, configured to perform layer 1 measurement; and
a reporting module, configured to report a layer 1 measurement result in a case that the layer 1 measurement result meets a first condition, where the first condition corresponds to an event configured by a network-side device.

According to a third aspect, a terminal is provided. The terminal includes a processor, a memory, and a program or instructions stored in the memory and capable of running on the processor. When the program or instructions are executed by the processor, the steps of the reporting method according to the first aspect are implemented.

According to a fourth aspect, a terminal is provided. The terminal includes a processor and a communication interface. The processor is configured to perform layer 1 measurement. The communication interface is configured to report a layer 1 measurement result in a case that the layer 1 measurement result meets a first condition corresponding to an event.

According to a fifth aspect, a readable storage medium is provided. The readable storage medium stores a program or instructions. When the program or instructions are executed by a processor, the reporting method according to the first aspect is implemented.

According to a sixth aspect, a chip is provided. The chip includes a processor and a communication interface. The communication interface is coupled to the processor. The processor is configured to run a program or instructions to implement the method according to the first aspect.

According to a seventh aspect, a computer program or program product is provided. The computer program or program product is stored in a non-transitory storage medium. The program or program product is executed by at least one processor to implement the steps of the reporting method according to the first aspect.

In the embodiments of this application, the terminal performs the layer 1 measurement, and in the case that the layer 1 measurement result meets the first condition, the terminal reports the layer 1 measurement result. In comparison with conventional reporting through layer 3, in the reporting method provided in this application, there is no need to obtain a layer 3 measurement result through temporal smoothing filtering of the layer 1 measurement result and then report the measurement result at layer 3. Instead, the measurement result can be directly reported at layer 1. Therefore, the network-side device can obtain the measurement result as early as possible, and real-time performance of mobility management is improved. In addition, in comparison with periodic reporting of the layer 1 measurement result, in the reporting method provided in this application, the layer 1 measurement result can be reported only when the layer 1 measurement result meets the first condition corresponding to the event configured by the network-side device. Therefore, reporting resource overheads can be reduced, and flexibility of scheduling by a base station is improved.

### BRIEF DESCRIPTION OF DRAWINGS

FIG. 1 is a block diagram of a wireless communications system to which an embodiment of this application may be applied;

FIG. 2 is a flowchart of a reporting method according to an embodiment of this application;

FIG. 3 is a first schematic diagram of a scenario of a reporting method according to an embodiment of this application;

FIG. 4 is a second schematic diagram of a scenario of a reporting method according to an embodiment of this application;

FIG. 5 is a structural diagram of a reporting apparatus according to an embodiment of this application;

FIG. 6 is a structural diagram of a communication device according to an embodiment of this application; and

FIG. 7 is a structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first,” “second,” and the like in this specification and claims of this application are used to distinguish between similar objects instead of describing a specified order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a Long Term Evolution (LTE)/LTE-Advanced (LTE-A) system, and can also be used in other wireless communications systems, such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the New Radio (NR) system is described for an illustrative purpose, and NR terms are used in most of the following descriptions. These technologies may also be applied to other applications than an NR system application, for example, a 6th Generation (6G) communications system.

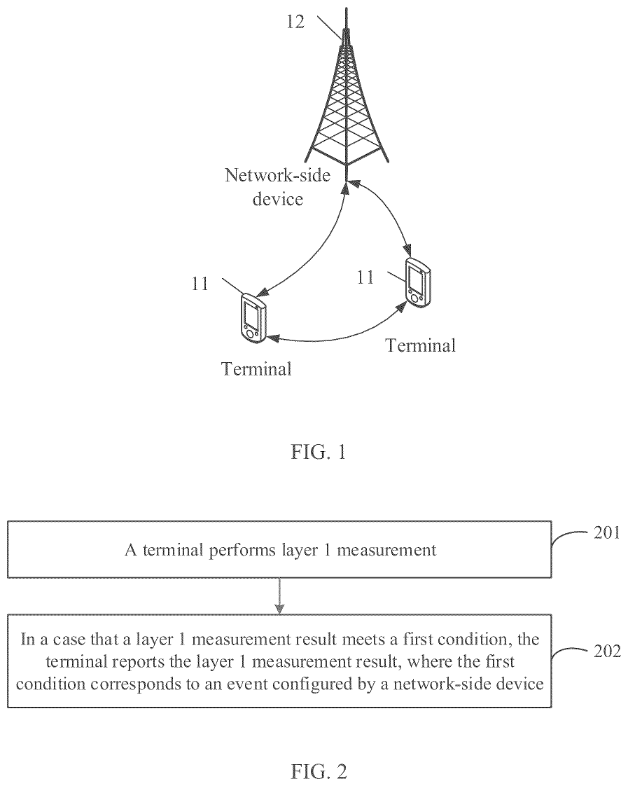

FIG. 1 is a block diagram of a wireless communications system to which an embodiment of this application may be applied. The wireless communications system includes a terminal 11 and a network-side device 12. The terminal 11 may also be referred to as a terminal device or User Equipment (UE). The terminal 11 may be a terminal-side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR) or Virtual Reality (VR) device, a robot, a wearable device, Vehicle User Equipment (VUE), Pedestrian User Equipment (PUE), or a smart home (a home device having a wireless communication function, such as a refrigerator, a television, a washing machine, or furniture). The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, a game console, or the like. It should be noted that a specific type of the terminal 11 is not limited in the embodiments of this application. The network-side device 12 may be a base station or a core network. The base station may be referred to as a NodeB, an evolved NodeB (eNB), an access point, a Base Transceiver Station (BTS), a radio base station, a radio transceiver, a Basic Service Set (BSS), an extended service set (Extended Service Set, ESS), a home NodeB, a home evolved NodeB, a WLAN access point, a Wi-Fi node, a Transmission and Reception Point (TRP), or another appropriate term in the art. As long as the same technical effect is achieved, the base station is not limited to specific technical terms. It should be noted that in the embodiments of this application, only a base station in an NR system is used as an example, but a specific type of the base station is not limited.

A reporting method and apparatus, and a related device provided in embodiments of this application are hereinafter described in detail by using some embodiments and application scenarios thereof with reference to the accompanying drawings.

FIG. 2 is a flowchart of a reporting method according to an embodiment of this application. As shown in FIG. 2, the reporting method includes the following steps.

Step 201: A terminal performs layer 1 measurement.

Step 202: In a case that a layer 1 measurement result meets a first condition, the terminal reports the layer 1 measurement result, where the first condition corresponds to an event configured by a network-side device.

It should be noted that layer 1 refers to a physical layer, and that layer 2 refers to a Media Access Control (MAC), or Radio Link Control (RLC), or Packet Data Convergence Protocol (PDCP) layer, and layer 3 refers to a Radio Resource Control (RRC) layer.

In some embodiments, the first condition includes any one of the following:
a layer 1 measurement result of at least one reference signal RS in a first measurement resource set is greater than a layer 1 measurement result of an RS in a second measurement resource set;
a layer 1 measurement result of at least one RS in the first measurement resource set is greater than a first threshold, and a layer 1 measurement result of at least one RS in the second measurement resource set is less than a second threshold;
a layer 1 measurement result of at least one RS in the first measurement resource set is less than a third threshold; and
a layer 1 measurement result of at least one RS in the second measurement resource set is less than a fourth threshold, where
the first measurement resource set or the second measurement resource set is determined by the terminal based on first configuration information.

It should be noted that the first configuration information is information configured by the network-side device, and that the first measurement resource set or the second measurement resource set is determined by the terminal based on the first configuration information by classifying measurement resources configured by the network-side device. For example, if the network-side device configures a plurality of measurement resources, the terminal may classify the plurality of measurement resources into the first measurement resource set and/or the second measurement resource set based on the first configuration information. In a case that the first condition includes the first measurement resource set and the second measurement resource set, the first measurement resource set and the second measurement resource set are determined by the terminal based on the first configuration information by classifying the measurement resources configured by the network-side device.

In this embodiment of this application, the event is an event configured by the network-side device. In the case that the layer 1 measurement result meets the first condition corresponding to the event, the terminal reports the layer 1 measurement result. The first condition may be any one of the foregoing four conditions.

For example, the first measurement resource set is a measurement resource set of a neighboring cell, and the second measurement resource set is a measurement resource set of a current serving cell. When the terminal performs layer 1 measurement on a Reference Signal (RS) of the neighboring cell and an RS of the current serving cell, if a layer 1 measurement result of an RS in the measurement resource set of the neighboring cell is greater than a layer 1 measurement result of an RS in the measurement resource set of the current serving cell, it is considered that the layer 1 measurement result meets the first condition, and the terminal reports the layer 1 measurement result.

In some alternative embodiments, when the terminal performs layer 1 measurement on an RS of the neighboring cell and an RS of the current serving cell, if a layer 1 measurement result of at least one RS in the measurement resource set of the neighboring cell is greater than the first threshold, and a layer 1 measurement result of at least one RS in the measurement resource set of the current serving cell is less than the second threshold, it is considered that the layer 1 measurement result meets the first condition, and the terminal reports the layer 1 measurement result.

It may be understood that the first condition is any one of the foregoing four conditions, and that reporting of the layer 1 measurement result by the terminal may also be other implementations. Details are not described herein in this embodiment of this application.

It should be noted that the first threshold, the second threshold, the third threshold, and the fourth threshold may be configured by using RRC signaling or values preset by the network-side device, which are not specifically limited in this embodiment of this application.

For better understanding, the following describes some of the foregoing four conditions in detail.

Condition 1: A layer 1 measurement result of at least one RS in the first measurement resource set is greater than a layer 1 measurement result of an RS in the second measurement resource set. The RS in the first measurement resource set is a first RS, and the RS in the second measurement resource set is a second RS. Formulas for determining condition 1 are shown in the following table.

| | |
|---|---|
| The first RS and the second RS are | Determining formula: Mn + Ofn + |
| associated with different Physical | Ocn − Hys > Mp + Ofp + Ocp + Off |
| Cell Identifiers (PCIs) | |
| The first RS and the second RS are | Determining formula: Mn − Hys > |
| associated with a same PCI | Mp or Mn − Hys > Mp + Hys |

Mn is the layer 1 measurement result of the first RS. Mp is the layer 1 measurement result corresponding to the second RS. Ofn, Ocn, Ofp, and Ocp are offset values configured by the network for layer 1 measurement of an RS of each cell. Off is an offset value between cells. Hys is a hysteresis value configured to avoid a ping-pong effect. It should be noted that the configuration of all offset values and hysteresis values is optional. When not configured, their values are equal to 0.

Condition 2: A layer 1 measurement result of at least one RS in the first measurement resource set is greater than the first threshold, and a layer 1 measurement result of at least one RS in the second measurement resource set is less than the second threshold. The RS in the first measurement resource set is a first RS, and the RS in the second measurement resource set is a second RS. Formulas for determining condition 2 are shown in the following table.

| | |
|---|---|
| The first RS and the second | Determining formula: Mn − Hys > Thresh1, |
| RS are associated with | and Mp + Ofp + Ocp + Hys < Thresh2 |
| different PCIs | |
| The first RS and the second | Determining formula: Mn − Hys > Thresh1, |
| RS are associated with a | and Mp + Hys < Thresh2 |
| same PCI | |

Mn is the layer 1 measurement result of the first RS. Mp is the layer 1 measurement result corresponding to the second RS. Ofp and Ocp are offset values configured by the network for layer 1 measurement of an RS of each cell. Thresh1 is the first threshold. Thresh2 is the second threshold. Hys is a hysteresis value configured to avoid a ping-pong effect. It should be noted that the configuration of all offset values and hysteresis values is optional. When not configured, their values are equal to 0.

Condition 3: A layer 1 measurement result of at least one RS in the first measurement resource set is less than the third threshold. The RS in the first measurement resource set is a first RS, and the RS in the second measurement resource set is a second RS. Determining formulas are shown in the following table.

| | |
|---|---|
| A PCI associated with the first RS is | Determining formula: Mn + |
| different from a PCI of the current | Ofn + Ocn + Hys < Thresh3 |
| serving cell | |
| The PCI associated with the first RS | Determining formula: Mn − |
| is the same as the PCI of the current | Hys > Thresh3 |
| serving cell | |

Mn is the layer 1 measurement result of the first RS. Ofn and Ocn are offset values configured by the network for layer 1 measurement of an RS of each cell. Thresh3 is the first threshold. Hys is a hysteresis value configured to avoid a ping-pong effect. It should be noted that the configuration of all offset values and hysteresis values is optional. When not configured, their values are equal to 0.

In this embodiment of this application, the first measurement resource set and the second measurement resource set are determined by the terminal based on the first configuration information by classifying the measurement resources configured by the network-side device. In some embodiments, the first configuration information includes at least one of the following:
cell list information;
at least one transmission configuration indicator TCI state currently activated by the network-side device;
a TCI state of a Control Resource Set (CORESET) 0;
a TCI state of a non-terminal-dedicated (Non-UE-dedicated) control resource set; and
frequency configuration information of a measurement resource.

In this embodiment of this application, depending on different events, the classification of the first measurement resource set and the second measurement resource set also varies. For example, the first configuration information includes the cell list information. If the event is defined as “beam quality of the neighboring cell is better than beam quality of the current serving cell,” the first measurement resource set is the measurement resource set of the neighboring cell (such as an RS set), and the second measurement resource set is the measurement resource set of the current serving cell.

In some alternative embodiments, the first configuration information includes the at least one Transmission Configuration Indicator (TCI) state currently activated by the network-side device. If the event is defined as “quality of a candidate beam is better than quality of a currently activated beam,” the first measurement resource set includes RSs of all the measurement resources configured by the network-side device except a Quasi Co-Location (QCL) source RS (including at least a QCL Type-D RS) corresponding to the at least one TCI state currently activated by the network-side device, and the second measurement resource set includes the QCL source RS (including at least the QCL Type-D RS) corresponding to the at least one TCL state currently activated by the network-side device.

In some alternative embodiments, the first configuration information includes the TCL state of the control resource set 0 (CORESET #0). If the event is defined as “quality of a candidate beam is better than current beam quality of the CORESET #0,” the first measurement resource set includes RSs of all the measurement resources configured by the network-side device except a QCL source RS (including at least a QCL Type-D RS) corresponding to the TCL state of the CORESET #0, and the second measurement resource set may include the QCL source RS (including at least the QCL Type-D RS) corresponding to the TCL state of the CORESET #0.

In some alternative embodiments, the first configuration information includes the TCL state of the non-terminal-dedicated control resource set. If the event is defined as “quality of a candidate beam is better than quality of a currently activated beam in the non-terminal-dedicated control resource set,” the first measurement resource set includes RSs of all the measurement resources configured by the network-side device except a QCL source RS (including at least a QCL Type-D RS) corresponding to the TCL state of the non-terminal-dedicated control resource set, and the second measurement resource set includes the QCL source RS (including at least the QCL Type-D RS) corresponding to the TCL state of the non-terminal-dedicated control resource set.

In some alternative embodiments, the first configuration information includes the frequency configuration information of the measurement resource. If the event is defined as “beam quality of a frequency band 1 is higher than beam quality of a frequency band 2,” the first measurement resource set may be RSs in the frequency band 1 among all the measurement resources configured by the network-side device, and the second measurement resource set may be RSs in the frequency band 2 among all the measurement resources configured by the network-side device. The frequency band 2 may be a frequency band corresponding to the current serving cell.

In this embodiment of this application, the layer 1 measurement result includes at least one of a layer 1 measurement result of an RS of the current serving cell and a layer 1 measurement result of an RS of the neighboring cell. For example, the terminal performs layer 1 measurement on the RS of the current serving cell and the RS of the neighboring cell. The layer 1 measurement result reported by the terminal may be the layer 1 measurement result of the RS of the current serving cell and the layer 1 measurement result of the RS of the neighboring cell, or may include only the layer 1 measurement result of the RS of the current serving cell or the layer 1 measurement result of the RS of the neighboring cell.

A PCI associated with the RS of the neighboring cell is different from the PCI of the current serving cell.

In this embodiment of this application, the terminal performs the layer 1 measurement, and in the case that the layer 1 measurement result meets the first condition corresponding to the event, the terminal reports the layer 1 measurement result. In comparison with conventional reporting through layer 3, in the reporting method provided in this application, there is no need to obtain a layer 3 measurement result through temporal smoothing filtering of the layer 1 measurement result and then report the measurement result at layer 3. Instead, the measurement result can be directly reported at layer 1. Therefore, the network-side device can obtain the measurement result as early as possible, and real-time performance of mobility management is improved. In addition, in comparison with periodic reporting of the layer 1 measurement result, in the reporting method provided in this application, the layer 1 measurement result can be reported only when the layer 1 measurement result meets the first condition corresponding to the event. Therefore, reporting resource overheads can be reduced, and flexibility of scheduling by a base station is improved.

In this embodiment of this application, the network-side device configures, for the terminal, configuration information for triggering a plurality of events; the terminal performs the layer 1 measurement; in a case that the layer 1 measurement result meets a first condition corresponding to any one of the plurality of events configured by the network-side device, the terminal triggers reporting of the layer 1 measurement result; and the network-side device determines, based on received report information, the first condition corresponding to which event is met by the layer 1 measurement result. For example, the terminal sends, to the network-side device, a RACH resource associated with an RS with a greatest layer 1 measurement result; and if the RS associated with the RACH resource belongs to the neighboring cell, the network-side device may determine, after receiving the RACH resource, that an event met by the reporting is that beam quality of an RS of the neighboring cell is higher than beam quality of an RS of the current serving cell.

In some alternative embodiments, the network-side device configures, for the terminal, configuration information for triggering only one event; and the terminal performs the layer 1 measurement and determines, based on a first condition corresponding to the event configured by the network-side device, whether to report the layer 1 measurement result.

In some embodiments, step 201 may include:
the terminal receives signaling configured by the network-side device, where the signaling includes configuration information of a measurement resource; and
the terminal performs the layer 1 measurement based on the configuration information of the measurement resource.

In this embodiment of this application, after receiving the signaling configured by the network-side device, the terminal may perform the layer 1 measurement based on the configuration information of the measurement resource carried in the signaling, and in the case that the layer 1 measurement result meets the first condition corresponding to the event, the terminal triggers reporting of the layer 1 measurement result.

In some embodiments, the configuration information of the measurement resource includes at least one of the following:
cell list information;
configuration information of an RS; and
configuration information of an SMTC.

For example, the configuration information of the measurement resource includes the configuration information of the RS. The RS may include a synchronization Synchronization Signal and PBCH block (SSB), a Channel State Information Reference Signal (CSI-RS) for mobility, a CSI-RS for beam management, a CSI-RS for tracking, a Sounding Reference Signal (SRS), or the like.

In some alternative embodiments, the configuration information of the measurement resource may further include the cell list information, or include the configuration information of the SMTC, or include the cell list information and the configuration information of the RS, or the like, which is not exhaustively listed herein in this application.

It should be noted that the configuration information of the measurement resource may be configured by using a new higher layer parameter, or may be configured by using an existing higher layer parameter, such as a higher layer parameter MeasObjectNR.

In some embodiments, the signaling configured by the network-side device further includes configuration information of a beam report, and based on the configuration information of the beam report, the terminal can determine beam information and a reporting resource for reporting the layer 1 measurement result.

In some embodiments, the configuration information of the beam report includes at least one of the following:
configuration information of a measurement resource associated with the beam report;
event trigger configuration information;
a quantity of reported beam information pairs;
a maximum quantity of cells allowed to be reported; and
configuration information of a reporting resource.

The measurement resource associated with the beam report includes at least a QCL source RS (QCL source RS) corresponding to at least one TCI state currently activated by the network-side device.

It should be noted that the terminal determines whether the layer 1 measurement result meets the first condition corresponding to the event. The event may be determined based on the event trigger configuration information. The event trigger configuration information is carried in the signaling sent by the network-side device. In other words, the terminal determines, based on the event configured by the network-side device, whether the layer 1 measurement result meets the first condition corresponding to the event.

In some embodiments, the event trigger configuration information includes at least one of the following:
an event trigger threshold;
duration of an event trigger timer;
a hysteresis value corresponding to the event;
a measurement offset value;
a maximum value of an event trigger counter;
an event-triggered reporting interval; and
an indication of reporting triggered due to inability to meet the first condition corresponding to the event.

The event trigger threshold may be a threshold for triggering an event. For example, when a threshold for triggering event A is reached, the terminal triggers reporting of the layer 1 measurement result in a case that the terminal determines that the layer 1 measurement result meets a first condition corresponding to event A. The duration of the event trigger timer may be duration of a timer for triggering an event. For example, when duration of a timer for triggering event B is reached, the terminal triggers reporting of the layer 1 measurement result if the terminal determines that the layer 1 measurement result meets a first condition corresponding to event B. The maximum value of the event trigger counter may be a maximum value of a counter for triggering an event. The event-triggered reporting interval may be an interval of reporting triggered by an event. Content included in the event trigger configuration information may be in a plurality of forms, which are not exhaustively listed in this embodiment of this application.

In some embodiments, one event corresponds to one piece of event trigger configuration information, or a plurality of events correspond to one piece of event trigger configuration information.

In this embodiment of this application, the beam information pair includes at least one of the following: a layer 1 measurement result, a measurement resource identifier, a cell identity, and frequency-related information.

In some embodiments, the layer 1 measurement result may include layer 1 Reference Signal Received Power (RSRP), layer 1 Reference Signal Received Quality (RSRQ), a layer 1 Signal to Interference plus Noise Ratio (SINR), or the like.

In some embodiments, the measurement resource identifier may include a CSI-RS Resource Indicator (CRI), an SSB Resource Indicator (SSBRI), a Sounding Reference Signal Resource Indicator (SRSRI), or the like.

In some embodiments, the cell identity may be a PCI, an indication of configuration information of the neighboring cell, or the like. The cell identity includes either of the physical cell identifier and an indication of related configuration information of the neighboring cell through bit mapping.

In some embodiments, the beam information pair may include the frequency-related information only for inter-frequency measurement, and the frequency-related information may be information about a frequency of the measurement resource or indication information indicating a frequency of the measurement resource.

In some embodiments, the quantity of beam information pairs is related to a capability of the terminal. For example, the quantity of beam information pairs is configured by the network-side device based on the capability of the terminal; and the maximum quantity of cells allowed to be reported may also be configured by the network-side device based on the capability of the terminal.

In some embodiments, the reporting resource includes at least one of the following: a configured grant and a Random Access Channel (RACH) resource.

The RACH resource is associated with the measurement resource associated with the beam report. For example, all SSBs corresponding to each PCI are associated with a same RACH resource, or different SSBs are associated with different RACH resources.

In some embodiments, at least one of the following operations is performed on at least one of the configuration information of the beam report and the configuration information of the measurement resource by using a Media Access Control Control Element (MAC CE): modification, deletion, addition, and update.

In some embodiments, the configuration information of the measurement resource and the configuration information of the beam report are separately encapsulated, and the measurement resource is associated with the beam report based on measurement configuration information.

For example, configuration information of all measurement resources is configured in a higher layer parameter MeasObjectNRList_r17, and configuration information of each measurement resource corresponds to an element MeasObjectNR_r17 in the MeasObjectNRList_r17 by using a MeasObjectNRId_r17. Similarly, configuration information of all beam reports is configured in a higher layer parameter ReportConfigList_r17, and configuration information of each beam report corresponds to an element ReportConfig_r17 in the ReportConfigList_r17 by using a ReportConfigld_r17. All measurement configuration information is configured in a higher layer parameter MeasConfigList_r17, each piece of measurement configuration information corresponds to an element MeasConfig_r17 in the MeasConfigList_r17 by using a MeasId_r17, and each MeasConfig_r17 includes at least one MeasId_r17, one MeasObjectNRId_r17, and one ReportConfigId_r17.

In some alternative embodiments, the configuration information of the beam report includes the configuration information of the measurement resource associated with the beam report. For example, in the configuration information of the beam report, one or more higher layer parameters are used to indicate all or some measurement resources of the current serving cell and the neighboring cell. For example, the corresponding resource is associated by using CSI-ReportConfig in the related art.

In this embodiment of this application, step 202 may include any one of the following:
in the case that the layer 1 measurement result meets the first condition corresponding to the event, the terminal triggers, through the physical layer, reporting of the layer 1 measurement result;
in a case that the physical layer of the terminal determines that the layer 1 measurement result always meets the first condition within the event-triggered reporting interval, the terminal reports a trigger indication of the event to the MAC layer through the physical layer, so that the MAC layer counts the trigger indication of the event by using an event trigger counter, and when a count value of the event trigger counter is greater than a preset value, the terminal triggers, through the MAC layer, reporting of the layer 1 measurement result;
the terminal reports the layer 1 measurement result to the MAC layer of the terminal, and in a case that the MAC layer determines that the layer 1 measurement result always meets the first condition within a preset time period, the terminal triggers, through the MAC layer, reporting of the layer 1 measurement result; and
the terminal reports the layer 1 measurement result to the MAC layer of the terminal, and in a case that the MAC layer determines that the layer 1 measurement result always fails to meet the first condition within a preset time period, the terminal triggers, through the MAC layer, reporting of the layer 1 measurement result.

For example, in an implementation, the terminal performs the layer 1 measurement, and in the case that the layer 1 measurement result meets the first condition corresponding to the event, the terminal triggers, through the physical layer, reporting of the layer 1 measurement result.

For example, in another implementation, the terminal may trigger, through the MAC layer, reporting of the layer 1 measurement result.

For example, in an implementation, the terminal performs the layer 1 measurement; when the physical layer of the terminal determines that the layer 1 measurement result always meets the first condition within the event-triggered reporting interval, the terminal reports the corresponding trigger indication of the event to the MAC layer through the physical layer; the MAC layer counts the trigger indication of the event by using the event trigger counter; and when the count value of the event trigger counter exceeds the maximum value preset or configured by the network-side device, the terminal triggers, through the MAC layer, reporting of the layer 1 measurement result.

It should be noted that, in a case that a second condition is met, the count value of the event trigger counter is cleared to zero, and the second condition includes any one of the following:
the MAC layer triggers reporting of the layer 1 measurement result;
the MAC layer completes processing and assembly of the layer 1 measurement result;
reporting of the layer 1 measurement result is completed; and
an event trigger timer expires.

Each time the MAC layer receives a trigger indication of the event, the event trigger timer restarts timing.

For example, in another implementation, the terminal performs the layer 1 measurement; the terminal reports the layer 1 measurement result to the MAC layer of the terminal; and in a case that the MAC layer determines that the layer 1 measurement result always meets the first condition within the preset time period, the terminal triggers, through the MAC layer, reporting of the layer 1 measurement result. That the layer 1 measurement result always meets the first condition within the preset time period may be that the layer 1 measurement result continuously meets the first condition within the preset time period. For example, the preset time period includes four continuous measurement periods. It is considered that the layer 1 measurement result always meets the first condition within the preset time period, and the terminal triggers, through the MAC layer, reporting of the layer 1 measurement result, only when the layer 1 measurement result meets the first condition within all of the four measurement periods. If the layer 1 measurement result does not meet the first condition within any one of the four measurement periods, it is considered that the layer 1 measurement result does not always meet the first condition within the preset time period, and the terminal does not trigger reporting of the layer 1 measurement result.

In another implementation, the terminal performs the layer 1 measurement; the terminal reports the layer 1 measurement result to the MAC layer of the terminal; and in a case that the MAC layer determines that the layer 1 measurement result always fails to meet the first condition within the preset time period, the terminal triggers, through the MAC layer, reporting of the layer 1 measurement result. For example, the preset time period includes four continuous measurement periods. It is considered that the layer 1 measurement result always fails to meet the first condition within the preset time period, and the terminal triggers, through the MAC layer, reporting of the layer 1 measurement result, only when the layer 1 measurement result fails to meet the first condition within all of the four measurement periods. If the layer 1 measurement result meets the first condition within any one of the four measurement periods, it is considered that the layer 1 measurement result does not always fail to meet the first condition within the preset time period, and the terminal does not trigger reporting of the layer 1 measurement result.

In some embodiments, that the terminal reports the layer 1 measurement result includes:
the terminal selects M layer 1 measurement results, and reports, on a first resource, beam information corresponding to the M layer 1 measurement results, where
the beam information includes M beam information pairs, and a value of M cannot exceed a quantity of reported beam information pairs that is configured by the network-side device. For example, if the quantity of reported beam information pairs that is configured by the network-side device is N, M≤N. In a case that the terminal triggers, through the physical layer, reporting of the layer 1 measurement result, because the network-side device has fixed a load size of Uplink Control Information (UCI), a quantity of beam information pairs reported by the terminal is the quantity of reported beam information pairs that is configured by the network-side device, that is, M=N. In a case that the terminal triggers, through MAC, reporting of the layer 1 measurement result, because a MAC CE size is scalable, the quantity of beam information pairs reported by the terminal may be less than or equal to the quantity of reported beam information pairs that is configured by the network-side device, that is, M≤N.

In some embodiments, that the terminal selects M layer 1 measurement results includes any one of the following:
the terminal selects M layer 1 measurement results in descending order of the layer 1 measurement results;
the terminal prioritizes cells according to a preset rule, and selects layer 1 measurement results greater than a fifth threshold cell by cell in descending order of cell priorities, until a quantity of the selected layer 1 measurement results is M; and the terminal prioritizes cells according to a preset rule, and selects M layer 1 measurement results greater than a sixth threshold from a preset quantity of cells in descending order of cell priorities, where the preset quantity is a maximum quantity of cells allowed to be reported that is configured by the network-side device.

The fifth threshold and the sixth threshold may be configured by using RRC signaling or values preset by the network-side device.

In some embodiments, the preset rule includes any one of the following:
cell quality;
an average value of beam quality of all RSs in a cell; and
a maximum value of beam quality of all RSs in a cell.

In some embodiments, the reporting, on a first resource, beam information corresponding to the M layer 1 measurement results includes either of the following:
mapping the beam information corresponding to the M layer 1 measurement results to UCI, and reporting by using the UCI; and
mapping the beam information corresponding to the M layer 1 measurement results to at least one MAC CE, and reporting by using the at least one MAC CE.

In a case that the terminal maps the beam information corresponding to the M layer 1 measurement results to the UCI, and reports by using the UCI, a field may be further added to the UCI to indicate that the UCI is beam information reported based on event triggering, for example, a beam report transmitted by using a PUCCH or an Uplink grant (UL grant).

In this embodiment of this application, that the terminal selects M layer 1 measurement results, and reports, on a first resource, beam information corresponding to the M layer 1 measurement results, where the beam information includes M beam information pairs, and the M beam information pairs are differentially reported, may include:
sorting the M beam information pairs in descending order of the layer 1 measurement results, reporting a layer 1 measurement result with a greatest layer 1 measurement value by using a true value, and reporting remaining layer 1 measurement results based on their differences from the greatest layer 1 measurement value; or
classifying the M beam information pairs based on cells, reporting a layer 1 measurement result with a greatest layer 1 measurement value in each cell by using a true value, and reporting remaining layer 1 measurement results in the cell based on their differences from the greatest layer 1 measurement value in the cell.

In some embodiments, the first resource includes any one of the following:
a configured grant configured and activated by the network-side device;
a RACH resource configured by the network-side device and associated with a measurement resource;
a PUCCH resource or a PUSCH resource that is available and closest to a time when the first condition is met;
an uplink grant resource that is available and closest to completion of MAC CE assembly;
a UL grant resource requested to be scheduled by using a PUCCH Scheduling Request (SR); and
information Msg_A or information Msg_3 in a RACH process.

The RACH resource configured by the network-side device and associated with the measurement resource is used for beam reporting between cells. For example, the terminal may select a RACH resource associated with a measurement resource with a best layer 1 measurement result for sending, to notify the network-side device that a corresponding event occurs. For example, if a reported RS belongs to the neighboring cell, the network-side device can also know that beam quality of the neighboring cell is higher than beam quality of the current serving cell.

The first resource includes the UL grant resource requested to be scheduled by using the PUCCH SR, and this may be intended for a case that no UL grant is available. The PUCCH SR may be a scheduling request used for event-triggered reporting, or may be shared with other SRs.

The first resource includes the information Msg_A or the information Msg_3 in the RACH process, and this may be intended for a case that no UL grant is available and that the PUCCH SR for event-triggered reporting is not configured. The RACH resource is associated with an RS with a greatest layer 1 measurement result in the current serving cell, or the RACH resource is associated with an RS with a greatest layer 1 measurement result among all the measurement resources configured by the network-side device.

In this embodiment of this application, the reporting, on a first resource, beam information corresponding to the M layer 1 measurement results further includes:
in a case that more than one beam report is reported on the first resource, determining, by the terminal, reported content on the first resource according to a preset priority rule, where
the preset priority rule includes at least one of the following:
a priority of an event-triggered layer 3 reported beam report is higher than a priority of an event-triggered layer 1 reported beam report, the priority of the event-triggered layer 1 reported beam report is higher than a priority of an aperiodic layer 1 reported beam report, the priority of the aperiodic layer 1 reported beam report is higher than a priority of a semi-persistent layer 1 reported beam report, and the priority of the semi-persistent layer 1 reported beam report is higher than a priority of a periodic layer 1 reported beam report; and a priority of a layer 1 reported beam report with a greater layer 1 measurement result is higher than a priority of a layer 1 reported beam report with a smaller layer 1 measurement result.

In this embodiment of this application, the terminal can measure the RS of the neighboring cell and the RS of the current serving cell through layer 1, determine whether the layer 1 measurement result meets the first condition corresponding to the event, and further selectively perform beam reporting. In comparison with periodic beam reporting, the reporting method provided in this application can improve effectiveness of the reported beam information and reduce energy consumption of the terminal. In addition, in comparison with conventional layer 3 reporting, the layer 1 based reporting method provided in this embodiment of this application enables the network-side device to obtain the beam quality of the neighboring cell as early as possible and perform cell handover in time, which is more conducive to terminal mobility management.

For better understanding, the technical solutions of the embodiments of this application are hereinafter described by using two embodiments.

### Embodiment 1

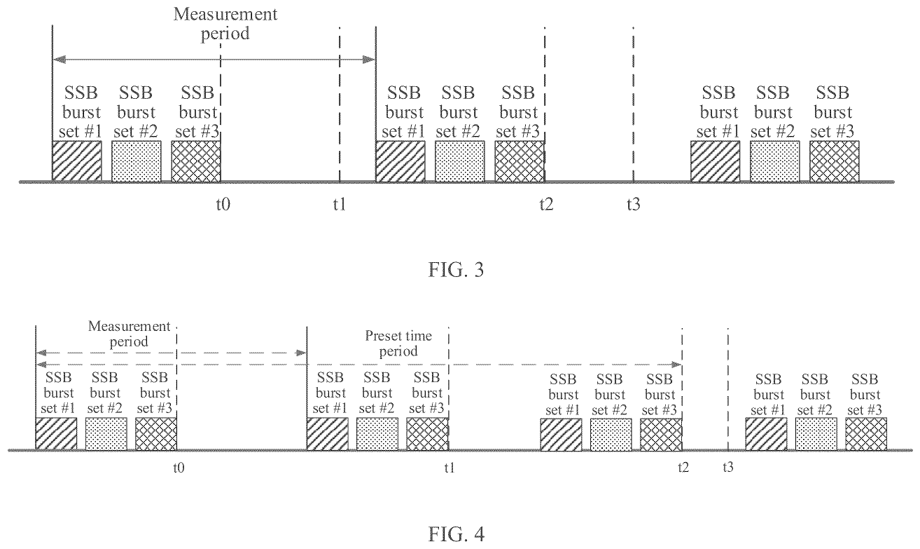

Referring to FIG. 3, assuming that there are three cells in configuration information of currently configured measurement resources and that RS measurement resources of each cell are independent, after layer 1 measurement of RSs in one or more measurement periods (one measurement period (Tperiod) in FIG. 3) is completed, statistics of beam measurement results are collected. If a layer 1 measurement result at a time to meets a first condition corresponding to an event, and there is an available PUCCH or PUSCH resource at a time t1 or a configured grant has been activated and has not been deactivated before a time t1, beam pair information including the layer 1 measurement result is reported on the available PUCCH resource or PUSCH resource or configured grant corresponding to the time t1, or a RACH resource associated with an SSB #0 is sent (assuming that a layer 1 measurement result of the SSB #0 is the greatest). If there is no available PUCCH or PUSCH resource at the time t1, and the configured grant has not been activated or has been deactivated, and a dedicated RACH resource associated with the SSB is not configured, the reported beam information pair is buffered and waits to be sent on an available uplink resource, until layer 1 measurement is started next time.

### Embodiment 2

Referring to FIG. 4, assuming that there are three cells in configuration information of currently configured measurement resources and that RS measurement resources of each cell are independent, after layer 1 measurement of RSs in one or more measurement periods (one measurement period (Tperiod) in FIG. 4) is completed, statistics of beam measurement results are collected, and a layer 1 measurement result is reported to a MAC layer of a terminal. The MAC layer determines whether the reported LI measurement result meets a first condition corresponding to an event. If the layer 1 measurement result always meets the first condition corresponding to the event or fails to always meet the first condition corresponding to the event within a preset time period (Timer), beam reporting is triggered. If an SSB1 in an SSB burst set #3 meets the first condition corresponding to the event at all of a time to, a time t1, and a time t2, beam reporting is triggered at the time t2, and beam information to be reported is assembled to generate a MAC CE. If there is an available UL grant or an activated configured grant at a time t3, the terminal sends the MAC CE carrying the beam information on the UL grant or configured grant. If the first condition is met at t0 and t2 but not met at the time t1, the terminal does not trigger beam reporting at the time t2. If beam reporting is triggered at the time t2, but there is no available UL grant and activated configured grant at the time t3, a reporting procedure is as follows:
1. If a network-side device has configured a PUCCH-SR resource for event-triggered reporting, the terminal sends a scheduling request by using the PUCCH-SR resource, and sends a MAC CE carrying beam information on a subsequently requested UL grant.
2. If the network has not configured a PUCCH-SR resource for event-triggered reporting, the terminal notifies the network-side device through a RACH that an event occurs and that beam reporting is required, and then sends a MAC CE carrying beam information in Msg_A or Msg_3, where the RACH may be Contention Based Random Access (CBRA) or Contention Free Random Access (CFRA).

It should be noted that the reporting method provided in this embodiment of this application may be performed by a reporting apparatus, or a control module configured to perform the reporting method in the reporting apparatus. A reporting apparatus provided in an embodiment of this application is described by assuming that the reporting method in this embodiment of this application is performed by the reporting apparatus.

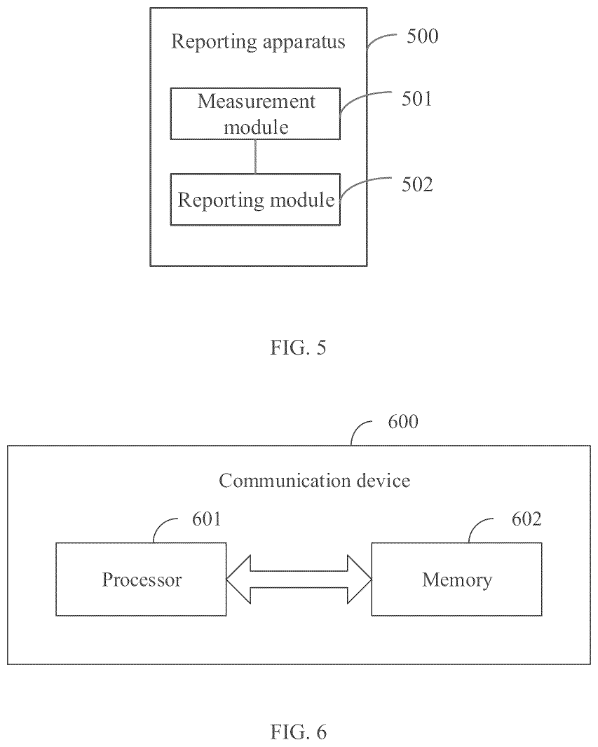

FIG. 5 is a structural diagram of a reporting apparatus according to an embodiment of this application. As shown in FIG. 5, the reporting apparatus 500 includes:
a measurement module 501, configured to perform layer 1 measurement; and
a reporting module 502, configured to report a layer 1 measurement result in a case that the layer 1 measurement result meets a first condition, where the first condition corresponds to an event configured by a network-side device.

In some embodiments, the first condition includes any one of the following:
a layer 1 measurement result of at least one reference signal RS in a first measurement resource set is greater than a layer 1 measurement result of an RS in a second measurement resource set;
a layer 1 measurement result of at least one RS in the first measurement resource set is greater than a first threshold, and a layer 1 measurement result of at least one RS in the second measurement resource set is less than a second threshold;
a layer 1 measurement result of at least one RS in the first measurement resource set is less than a third threshold; and
a layer 1 measurement result of at least one RS in the second measurement resource set is less than a fourth threshold, where
the first measurement resource set or the second measurement resource set is determined by the apparatus based on first configuration information.

In some embodiments, the first configuration information includes at least one of the following:
cell list information;
at least one transmission configuration indicator TCI state currently activated by the network-side device;
a TCI state of a control resource set 0;
a TCI state of a non-terminal-dedicated control resource set; and
frequency configuration information of a measurement resource.

In some embodiments, the layer 1 measurement result includes at least one of a layer 1 measurement result of an RS of a current serving cell and a layer 1 measurement result of an RS of a neighboring cell.

In some embodiments, a physical cell identifier PCI associated with the RS of the neighboring cell is different from a PCI of the current serving cell.

In some embodiments, the measurement module 501 is further configured to:
receive signaling configured by the network-side device, where the signaling includes configuration information of a measurement resource; and
perform the layer 1 measurement based on the configuration information of the measurement resource.

In some embodiments, the configuration information of the measurement resource includes at least one of the following:
cell list information;
configuration information of an RS; and
configuration information of a synchronization signal/physical broadcast channel block measurement timing configuration SMTC.

In some embodiments, the signaling further includes configuration information of a beam report.

In some embodiments, the configuration information of the beam report includes at least one of the following:
configuration information of a measurement resource associated with the beam report;
event trigger configuration information;
a quantity of reported beam information pairs;
a maximum quantity of cells allowed to be reported; and
configuration information of a reporting resource.

In some embodiments, the measurement resource associated with the beam report includes a QCL source RS corresponding to at least one TCI state currently activated by the network-side device.

In some embodiments, the event trigger configuration information includes at least one of the following:
an event trigger threshold;
duration of an event trigger timer;
a hysteresis value corresponding to the event;
a measurement offset value;
a maximum value of an event trigger counter;
an event-triggered reporting interval; and
an indication of reporting triggered due to inability to meet the first condition corresponding to the event.

In some embodiments, one event corresponds to one piece of event trigger configuration information, or a plurality of events correspond to one piece of event trigger configuration information.

In some embodiments, the beam information pair includes at least one of the following:
a layer 1 measurement result;
a measurement resource identifier;
a cell identity; and
frequency-related information.

In some embodiments, the quantity of beam information pairs is related to a capability of the terminal.

In some embodiments, the reporting resource includes at least one of the following:
a configured grant; and
a random access channel RACH resource.

In some embodiments, the RACH resource is associated with the measurement resource associated with the beam report.

In some embodiments, at least one of the following operations is performed on at least one of the configuration information of the beam report and the configuration information of the measurement resource by using a MAC CE: modification, deletion, addition, and update.

In some embodiments, the reporting module 502 is further configured to perform any one of the following:
in the case that the layer 1 measurement result meets the first condition corresponding to the event, triggering, through a physical layer, reporting of the layer 1 measurement result;
in a case that the physical layer determines that the layer 1 measurement result always meets the first condition within an event-triggered reporting interval, reporting, by the apparatus, a trigger indication of the event to a MAC layer through the physical layer, so that the MAC layer counts the trigger indication of the event by using an event trigger counter, and when a count value of the event trigger counter is greater than a preset value, triggering, by the apparatus through the MAC layer, reporting of the layer 1 measurement result;
reporting the layer 1 measurement result to the MAC layer of the apparatus, and in a case that the MAC layer determines that the layer 1 measurement result always meets the first condition within a preset time period, triggering, through the MAC layer, reporting of the layer 1 measurement result; and
reporting the layer 1 measurement result to the MAC layer of the apparatus, and in a case that the MAC layer determines that the layer 1 measurement result always fails to meet the first condition within a preset time period, triggering, through the MAC layer, reporting of the layer 1 measurement result.

In some embodiments, in a case that a second condition is met, the count value of the event trigger counter is cleared to zero, and the second condition includes any one of the following:
the MAC layer triggers reporting of the layer 1 measurement result;
the MAC layer completes processing and assembly of the layer 1 measurement result;
reporting of the layer 1 measurement result is completed; and
an event trigger timer expires.

In some embodiments, each time the MAC layer receives a trigger indication of the event, the event trigger timer restarts timing.

In some embodiments, the reporting module 502 is further configured to:
select M layer 1 measurement results, and report, on a first resource, beam information corresponding to the M layer 1 measurement results, where
the beam information includes M beam information pairs, and a value of M cannot exceed a quantity of reported beam information pairs that is configured by the network-side device.

In some embodiments, the reporting module 502 is further configured to perform any one of the following:
selecting M layer 1 measurement results in descending order of the layer 1 measurement results;
prioritizing cells according to a preset rule, and selecting layer 1 measurement results greater than a fifth threshold cell by cell in descending order of cell priorities, until a quantity of the selected layer 1 measurement results is M; and
prioritizing cells according to a preset rule, and selecting M layer 1 measurement results greater than a sixth threshold from a preset quantity of cells in descending order of cell priorities, where the preset quantity is a maximum quantity of cells allowed to be reported that is configured by the network-side device.

In some embodiments, the reporting module 502 is further configured to perform either of the following:
mapping the beam information corresponding to the M layer 1 measurement results to uplink control information UCI, and reporting by using the UCI; and
mapping the beam information corresponding to the M layer 1 measurement results to at least one MAC CE, and reporting by using the at least one MAC CE.

In some embodiments, the first resource includes at least one of the following:
a configured grant configured and activated by the network-side device;
a RACH resource configured by the network-side device and associated with a measurement resource;
a physical uplink control channel PUCCH resource or a physical uplink shared channel PUSCH resource that is available and closest to a time when the first condition is met;
an uplink grant resource that is available and closest to completion of MAC CE assembly;
an uplink grant resource requested to be scheduled by using a PUCCH scheduling request SR; and
information Msg_A or information Msg_3 in a RACH process.

In some embodiments, the reporting module 502 is further configured to:
in a case that more than one beam report is reported on the first resource, determine reported content on the first resource according to a preset priority rule, where
the preset priority rule includes at least one of the following:
a priority of an event-triggered layer 3 reported beam report is higher than a priority of an event-triggered layer 1 reported beam report, the priority of the event-triggered layer 1 reported beam report is higher than a priority of an aperiodic layer 1 reported beam report, the priority of the aperiodic layer 1 reported beam report is higher than a priority of a semi-persistent layer 1 reported beam report, and the priority of the semi-persistent layer 1 reported beam report is higher than a priority of a periodic layer 1 reported beam report; and
a priority of a layer 1 reported beam report with a greater layer 1 measurement result is higher than a priority of a layer 1 reported beam report with a smaller layer 1 measurement result.

In this embodiment of this application, the measurement module 501 performs the layer 1 measurement, and in the case that the layer 1 measurement result meets the first condition corresponding to the event, the reporting module 502 reports the layer 1 measurement result. In comparison with conventional reporting through layer 3, in the solution provided in this application, there is no need to obtain a layer 3 measurement result through temporal smoothing filtering of the layer 1 measurement result and then report the measurement result at layer 3. Instead, the measurement result can be directly reported at layer 1. Therefore, the network-side device can obtain the measurement result as early as possible, and real-time performance of mobility management is improved. In addition, in comparison with periodic reporting of the layer 1 measurement result, the reporting apparatus provided in this application can report the layer 1 measurement result only when the layer 1 measurement result meets the first condition corresponding to the event. Therefore, reporting resource overheads can be reduced, and flexibility of scheduling by a base station is improved.

The reporting apparatus 500 in this embodiment of this application may be an apparatus, or an apparatus or an electronic device with an operating system, or may be a component, an integrated circuit, or a chip in a terminal. The apparatus or the electronic device may be a mobile terminal, or may be a nonmobile terminal. For example, the mobile terminal may include but is not limited to the foregoing illustrated type of the terminal 11. The nonmobile terminal may be a server, a Network Attached Storage (NAS), a Personal Computer (PC), a Television (TV), a teller machine, a self-service machine, or the like. This is not specifically limited in this embodiment of this application.

The reporting apparatus 500 provided in this embodiment of this application can implement each process implemented by the method embodiments in FIG. 2 to FIG. 4, with the same technical effect achieved. To avoid repetition, details are not described herein again.

In some embodiments, as shown in FIG. 6, an embodiment of this application further provides a communication device 600, including a processor 601, a memory 602, and a program or instructions stored in the memory 602 and capable of running on the processor 601. For example, when the communication device 600 is a terminal, and the program or instructions are executed by the processor 601, each process of the foregoing embodiment of the reporting method is implemented, with the same technical effect achieved. To avoid repetition, details are not described herein again.

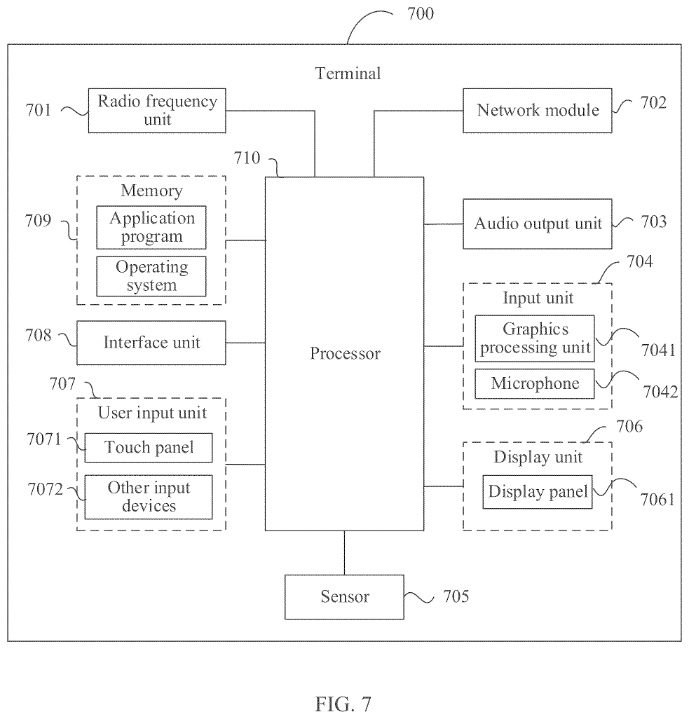

An embodiment of this application further provides a terminal, including a processor and a communication interface. The processor is configured to perform layer 1 measurement. The communication interface is configured to report a layer 1 measurement result in a case that the layer 1 measurement result meets a first condition corresponding to an event. The terminal embodiment corresponds to the foregoing terminal-side method embodiment, and each implementation process and implementation of the foregoing method embodiment can be applied to the terminal embodiment, with the same technical effect achieved. For example, FIG. 7 is a schematic diagram of a hardware structure of a terminal for implementing an embodiment of this application.

The terminal 700 includes but is not limited to at least some components such as a radio frequency unit 701, a network module 702, an audio output unit 703, an input unit 704, a sensor 705, a display unit 706, a user input unit 707, an interface unit 708, a memory 709, and a processor 710.

A person skilled in the art may understand that the terminal 700 may further include a power supply (for example, a battery) supplying power to all components. The power supply may be logically connected to the processor 710 through a power management system. In this way, functions such as charge management, discharge management, and power consumption management are implemented by using the power management system. The terminal structure shown in FIG. 7 does not constitute a limitation on the terminal. The terminal may include more or fewer components than those shown in the figure, or some components are combined, or component arrangements are different. Details are not described herein again.

It should be understood that, in this embodiment of this application, the input unit 704 may include a Graphics Processing Unit (GPU) 7041 and a microphone 7042. The graphics processing unit 7041 processes image data of a still picture or video obtained by an image capture apparatus (such as a camera) in a video capture mode or an image capture mode. The display unit 706 may include a display panel 7061, and the display panel 7061 may be configured in a form of a liquid crystal display, an organic light-emitting diode, or the like. The user input unit 707 includes a touch panel 7071 and other input devices 7072. The touch panel 7071 is also referred to as a touchscreen. The touch panel 7071 may include two parts: a touch detection apparatus and a touch controller. The other input devices 7072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 701 sends the downlink data to the processor 710 for processing, and in addition, sends uplink data to the network-side device. Generally, the radio frequency unit 701 includes but is not limited to an antenna, at least one amplifier, a transceiver, a coupler, a low noise amplifier, a duplexer, and the like.

The memory 709 may be configured to store software programs or instructions and various data. The memory 709 may primarily include a program or instruction storage area and a data storage area. The program or instruction storage area may store an operating system, an application program or instructions (such as an audio play function and an image play function) required by at least one function, and the like. In addition, the memory 709 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 710 may include one or more processing units. In some embodiments, the processor 710 may integrate an application processor and a modem processor. The application processor mainly processes the operating system, a user interface, an application program, or an instruction. The modem processor mainly processes wireless communication. For example, the modem processor is a baseband processor. It may be understood that the modem processor may not be integrated in the processor 710.

The processor 710 is configured to perform layer 1 measurement.

The radio frequency unit 701 is configured to report, by the terminal, a layer 1 measurement result in a case that the layer 1 measurement result meets a first condition, where the first condition corresponds to an event configured by a network-side device.

In some embodiments, the first condition includes any one of the following:
a layer 1 measurement result of at least one reference signal RS in a first measurement resource set is greater than a layer 1 measurement result of an RS in a second measurement resource set;
a layer 1 measurement result of at least one RS in the first measurement resource set is greater than a first threshold, and a layer 1 measurement result of at least one RS in the second measurement resource set is less than a second threshold;
a layer 1 measurement result of at least one RS in the first measurement resource set is less than a third threshold; and
a layer 1 measurement result of at least one RS in the second measurement resource set is less than a fourth threshold, where
the first measurement resource set or the second measurement resource set is determined by the terminal based on first configuration information.

In some embodiments, the first configuration information includes at least one of the following:
cell list information;
at least one transmission configuration indicator TCI state currently activated by the network-side device;
a TCI state of a control resource set 0;
a TCI state of a non-terminal-dedicated control resource set; and
frequency configuration information of a measurement resource.

In some embodiments, the layer 1 measurement result includes at least one of a layer 1 measurement result of an RS of a current serving cell and a layer 1 measurement result of an RS of a neighboring cell.

In some embodiments, a PCI associated with the RS of the neighboring cell is different from a PCI of the current serving cell.

In some embodiments, the processor 710 is further configured to:
receive signaling configured by the network-side device, where the signaling includes configuration information of a measurement resource; and
perform the layer 1 measurement based on the configuration information of the measurement resource.

In some embodiments, the configuration information of the measurement resource includes at least one of the following:
cell list information;
configuration information of an RS; and
configuration information of a synchronization signal/physical broadcast channel block measurement timing configuration SMTC.

In some embodiments, the signaling further includes configuration information of a beam report.

In some embodiments, the configuration information of the beam report includes at least one of the following:
configuration information of a measurement resource associated with the beam report;
event trigger configuration information;
a quantity of reported beam information pairs;
a maximum quantity of cells allowed to be reported; and
configuration information of a reporting resource.

In some embodiments, the measurement resource associated with the beam report includes a QCL source RS corresponding to at least one TCI state currently activated by the network-side device.

In some embodiments, the event trigger configuration information includes at least one of the following:
an event trigger threshold;
duration of an event trigger timer;
a hysteresis value corresponding to the event;
a measurement offset value;
a maximum value of an event trigger counter;
an event-triggered reporting interval; and
an indication of reporting triggered due to inability to meet the first condition corresponding to the event.

In some embodiments, one event corresponds to one piece of event trigger configuration information, or a plurality of events correspond to one piece of event trigger configuration information.

In some embodiments, the beam information pair includes at least one of the following:
a layer 1 measurement result;
a measurement resource identifier;
a cell identity; and
frequency-related information.

In some embodiments, the quantity of beam information pairs is related to a capability of the terminal.

In some embodiments, the reporting resource includes at least one of the following:
a configured grant; and
a random access channel RACH resource.

In some embodiments, the RACH resource is associated with the measurement resource associated with the beam report.

In some embodiments, at least one of the following operations is performed on at least one of the configuration information of the beam report and the configuration information of the measurement resource by using a MAC CE: modification, deletion, addition, and update.

In some embodiments, the radio frequency unit 701 is further configured to perform any one of the following:
in the case that the layer 1 measurement result meets the first condition corresponding to the event, triggering, through a physical layer, reporting of the layer 1 measurement result;
in a case that the physical layer of the terminal determines that the layer 1 measurement result always meets the first condition within an event-triggered reporting interval, reporting a trigger indication of the event to a MAC layer through the physical layer, so that the MAC layer counts the trigger indication of the event by using an event trigger counter, and when a count value of the event trigger counter is greater than a preset value, triggering, through the MAC layer, reporting of the layer 1 measurement result;
reporting the layer 1 measurement result to the MAC layer of the terminal, and in a case that the MAC layer determines that the layer 1 measurement result always meets the first condition within a preset time period, triggering, through the MAC layer, reporting of the layer 1 measurement result; and
reporting the layer 1 measurement result to the MAC layer of the terminal, and in a case that the MAC layer determines that the layer 1 measurement result always fails to meet the first condition within a preset time period, triggering, through the MAC layer, reporting of the layer 1 measurement result.

In some embodiments, in a case that a second condition is met, the count value of the event trigger counter is cleared to zero, and the second condition includes any one of the following:
the MAC layer triggers reporting of the layer 1 measurement result;
the MAC layer completes processing and assembly of the layer 1 measurement result;
reporting of the layer 1 measurement result is completed; and
an event trigger timer expires.

In some embodiments, each time the MAC layer receives a trigger indication of the event, the event trigger timer restarts timing.

In some embodiments, the radio frequency unit 701 is further configured to:
select M layer 1 measurement results, and report, on a first resource, beam information corresponding to the M layer 1 measurement results, where
the beam information includes M beam information pairs, and a value of M cannot exceed a quantity of reported beam information pairs that is configured by the network-side device.

In some embodiments, the processor 710 is further configured to perform any one of the following:
selecting M layer 1 measurement results in descending order of the layer 1 measurement results;
prioritizing cells according to a preset rule, and selecting layer 1 measurement results greater than a fifth threshold cell by cell in descending order of cell priorities, until a quantity of the selected layer 1 measurement results is M; and
prioritizing cells according to a preset rule, and selecting M layer 1 measurement results greater than a sixth threshold from a preset quantity of cells in descending order of cell priorities, where the preset quantity is a maximum quantity of cells allowed to be reported that is configured by the network-side device.

In some embodiments, the processor 710 is further configured to perform either of the following:
mapping the beam information corresponding to the M layer 1 measurement results to uplink control information UCI, and reporting by using the UCI; and
mapping the beam information corresponding to the M layer 1 measurement results to at least one MAC CE, and reporting by using the at least one MAC CE.

In some embodiments, the first resource includes at least one of the following:
a configured grant configured and activated by the network-side device;
a RACH resource configured by the network-side device and associated with a measurement resource;
a physical uplink control channel PUCCH resource or a physical uplink shared channel PUSCH resource that is available and closest to a time when the first condition is met;
an uplink grant resource that is available and closest to completion of MAC CE assembly;
an uplink grant resource requested to be scheduled by using a PUCCH scheduling request SR; and
information Msg_A or information Msg_3 in a RACH process.

In some embodiments, the processor 710 is further configured to:
in a case that more than one beam report is reported on the first resource, determine reported content on the first resource according to a preset priority rule, where
the preset priority rule includes at least one of the following:
a priority of an event-triggered layer 3 reported beam report is higher than a priority of an event-triggered layer 1 reported beam report, the priority of the event-triggered layer 1 reported beam report is higher than a priority of an aperiodic layer 1 reported beam report, the priority of the aperiodic layer 1 reported beam report is higher than a priority of a semi-persistent layer 1 reported beam report, and the priority of the semi-persistent layer 1 reported beam report is higher than a priority of a periodic layer 1 reported beam report; and
a priority of a layer 1 reported beam report with a greater layer 1 measurement result is higher than a priority of a layer 1 reported beam report with a smaller layer 1 measurement result.

The terminal 700 provided in this embodiment of this application can implement each process implemented by the terminal in the method embodiment in FIG. 2, with the same technical effect achieved. To avoid repetition, details are not described herein again.

An embodiment of this application further provides a readable storage medium. The readable storage medium stores a program or instructions. When the program or instructions are executed by a processor, each process of the foregoing embodiment of the reporting method is implemented, with the same technical effect achieved. To avoid repetition, details are not described herein again.

The processor is a processor in the terminal in the foregoing embodiment. The readable storage medium includes a computer-readable storage medium, for example, a computer ROM, a Random Access Memory (RAM), a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the reporting method, with the same technical effect achieved. To avoid repetition, details are not described herein again.

It should be understood that the chip provided in this embodiment of this application may also be referred to as a system-level chip, a system chip, a chip system, a system-on-chip, or the like.

It should be noted that in this specification, the term “comprise,” “include,” or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, or may be implemented by using hardware. In some embodiments, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing embodiments. The foregoing embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A reporting method, comprising:
performing, by a terminal, layer 1 measurement; and
when a layer 1 measurement result meets a first condition, reporting, by the terminal, the layer 1 measurement result, wherein the first condition corresponds to an event configured by a network-side device.

2. The reporting method according to claim 1, wherein the first condition comprises any one of the following:
a layer 1 measurement result of at least one Reference Signal (RS) in a first measurement resource set is greater than a layer 1 measurement result of an RS in a second measurement resource set;
a layer 1 measurement result of at least one RS in the first measurement resource set is greater than a first threshold, and a layer 1 measurement result of at least one RS in the second measurement resource set is less than a second threshold;
a layer 1 measurement result of at least one RS in the first measurement resource set is less than a third threshold; or
a layer 1 measurement result of at least one RS in the second measurement resource set is less than a fourth threshold, wherein
the first measurement resource set or the second measurement resource set is determined by the terminal based on first configuration information.

3. The reporting method according to claim 2, wherein the first configuration information comprises at least one of the following:
cell list information;
at least one Transmission Configuration Indicator (TCI) state currently activated by the network-side device;
a TCI state of a control resource set 0;
a TCI state of a non-terminal-dedicated control resource set; or
frequency configuration information of a measurement resource.

4. The reporting method according to claim 1, wherein the layer 1 measurement result comprises at least one of a layer 1 measurement result of an RS of a current serving cell and a layer 1 measurement result of an RS of a neighboring cell.

5. The reporting method according to claim 4, wherein a Physical Cell Identifier (PCI) associated with the RS of the neighboring cell is different from a PCI of the current serving cell.

6. The reporting method according to claim 1, wherein performing, by the terminal, the layer 1 measurement comprises:
receiving, by the terminal, signaling configured by the network-side device, wherein the signaling comprises configuration information of a measurement resource; and
performing, by the terminal, the layer 1 measurement based on the configuration information of the measurement resource.

7. The reporting method according to claim 6, wherein the configuration information of the measurement resource comprises at least one of the following:
cell list information;
configuration information of a Reference Signal (RS); or
configuration information of a Synchronization signal/physical broadcast channel block Measurement Timing Configuration (SMTC).

8. The reporting method according to claim 6, wherein the signaling further comprises configuration information of a beam report.

9. The reporting method according to claim 8, wherein the configuration information of the beam report comprises at least one of the following:
configuration information of a measurement resource associated with the beam report;
event trigger configuration information;
a quantity of reported beam information pairs;
a maximum quantity of cells allowed to be reported; or
configuration information of a reporting resource.

10. The reporting method according to claim 9, wherein the measurement resource associated with the beam report comprises a Quasi-Co-Location (QCL) source Reference Signal (RS) corresponding to at least one Transmission Configuration Indicator (TCI) state currently activated by the network-side device.

11. The reporting method according to claim 9, wherein the event trigger configuration information comprises at least one of the following:
an event trigger threshold;
duration of an event trigger timer;
a hysteresis value corresponding to the event;
a measurement offset value;
a maximum value of an event trigger counter;
an event-triggered reporting interval; or
an indication of reporting triggered due to inability to meet the first condition corresponding to the event.

12. The reporting method according to claim 9, wherein one event corresponds to one piece of event trigger configuration information, or a plurality of events correspond to one piece of event trigger configuration information.

13. The reporting method according to claim 9, wherein the beam information pair comprises at least one of the following:
a layer 1 measurement result;
a measurement resource identifier;
a cell identity; or
frequency-related information.

14. The reporting method according to claim 9, wherein the quantity of beam information pairs is related to a capability of the terminal.

15. The reporting method according to claim 9, wherein the reporting resource comprises at least one of the following:
a configured grant; or
a Random Access Channel (RACH) resource.

16. The reporting method according to claim 15, wherein the RACH resource is associated with the measurement resource associated with the beam report.

17. The reporting method according to claim 8, wherein at least one of the following operations is performed on at least one of the configuration information of the beam report or the configuration information of the measurement resource by using a Media Access Control Control Element (MAC CE) modification, deletion, addition, or update.

18. The reporting method according to claim 1, wherein when the layer 1 measurement result meets the first condition corresponding to the event, the reporting, by the terminal, the layer 1 measurement result comprises any one of the following:
when the layer 1 measurement result meets the first condition corresponding to the event, triggering, by the terminal through a physical layer, reporting of the layer 1 measurement result;
when the physical layer of the terminal determines that the layer 1 measurement result meets the first condition within an event-triggered reporting interval, reporting, by the terminal, a trigger indication of the event to a MAC layer through the physical layer, so that the MAC layer counts the trigger indication of the event by using an event trigger counter, and when a count value of the event trigger counter is greater than a preset value, triggering, by the terminal through the MAC layer, reporting of the layer 1 measurement result;
reporting, by the terminal, the layer 1 measurement result to the MAC layer of the terminal, and when the MAC layer determines that the layer 1 measurement result meets the first condition within a preset time period, triggering, by the terminal through the MAC layer, reporting of the layer 1 measurement result; or
reporting, by the terminal, the layer 1 measurement result to the MAC layer of the terminal, and when the MAC layer determines that the layer 1 measurement result fails to meet the first condition within a preset time period, triggering, by the terminal through the MAC layer, reporting of the layer 1 measurement result.

19. A terminal, comprising a processor; and a memory having instructions stored in the memory and capable of running on the processor, wherein the instructions, when executed by the processor, cause the processor to perform operations comprising:
performing, by a terminal, layer 1 measurement; and
when a layer 1 measurement result meets a first condition, reporting, by the terminal, the layer 1 measurement result, wherein the first condition corresponds to an event configured by a network-side device.

20. A non-transitory computer-readable storage medium storing instructions that, when executed by a processor, cause the processor to perform operations comprising:
performing, by a terminal, layer 1 measurement; and
when a layer 1 measurement result meets a first condition, reporting, by the terminal, the layer 1 measurement result, wherein the first condition corresponds to an event configured by a network-side device.
